(19) United States
(12) Patent Application Publication
(10) Pub. No.: US 2007/0065066 A1
(43) Pub. Date: Mar. 22, 2007

(54) Wheel bearing retention apparatuses and methods

(75) Inventors: Mark Riches, Waterford, MI (US); Chris Oakwood, West Bloomfield, MI (US)

Correspondence Address: TROUTMAN SANDERS LLP/FGTL, 600 PEACHTREE STREET, SUITE 5200, ATLANTA, GA, 30308, US

(73) Assignee: Ford Global Technologies, LLC, Dearborn, MI (US)

(21) Appl. No.: 11/228,760

(22) Filed: Sep. 16, 2005

(51) Int. Cl. F16C 13/00

(52) U.S. Cl. 384/544

(57) ABSTRACT

A hub assembly is described. The hub assembly includes a roll formed hub connected to the hub assembly, at least one bearing enabling rotation of the hub assembly, and an inner ring in communication with at least one bearing and the roll formed hub. The hub assembly further includes a locking device adapted to lock the inner ring to the roll formed hub by a fusion weld.

### TECHNICAL FIELD

The present invention relates generally to wheel hubs and, more particularly, to a roll formed hub of the wheel hub secured to a bearing assembly, enabling wheel bearing retention.

### BACKGROUND

Wheel bearing assemblies allow wheel and tire assemblies to rotate fully around an axle. Wheel bearing assemblies contain either ball or roll bearings, which are in contact with a hub assembly. Typically, the outermost bearings are held in place by a portion of the hub and an outer race. The inner bearings, however, are usually held in place by a portion of the hub and a small inner ring. The inner ring is in turn held in place by a central bolt. Unfortunately, the central bolt used to hold the inner ring in place has several drawbacks. First, the central bolt may become loose due to normal operation, which may result in an end play condition. Second, the central bolt increases the complexity of the hub and also the manufacturing costs. Furthermore, the central hub increases the overall weight of the hub assembly.

Several methods have been proposed to eliminate the central bolt structure. One method involves welding the inner ring to the axial inner end portion of the hub assembly. Another method involves welding a retaining washer to the hub assembly. Although both of these methods eliminate the central bolts; unfortunately, any lateral load experienced by the hub assembly is applied directly to the weld joint, which can lead to failure of the hub assembly and possibly wheel separation.

Yet another method for retaining the bearing assembly is to form a shoulder at the distal end of the hub by rolling the axial inner portion of the distal end of the hub to form a shoulder; this configuration is known as a roll formed hub assembly. The shoulder abuts against the annular member thereby locking the bearing assembly within the hub.

Under extreme driving conditions, however, a lateral load applied to the bearing can cause the roll formed hub connected to the bearing to yield or elongate. As the roll formed hub yields, it separates from a small inner ring of the bearing assembly. This may create a loose condition, commonly referred to as end play. The wheel bearing, consequently, will have reduced bearing life, and could create a wheel wobble, and in some extreme instances dangerous and adverse conditions, such as wheel separation.

An example of this is as a vehicle enters a turn, a lateral acceleration or a lateral force pushes against the bottom of a tire causing forces to push against the shoulder. These forces can loosen the pre-load set on the bearings and on the shoulder. Since the outer bearing and the inner bearing are spinning, due to motion of the vehicle, damage can occur across the entire bearing assembly.

Another method for retaining the bearing assembly is to use a stub shaft in the hub assembly. The stub shaft method helps retain the washer or inner ring to the hub assembly. Unfortunately, the stub shaft method requires extra weight, adds significantly to material costs, and further requires additional labor to complete the assembly.

What is needed, therefore, is a solution to reduce the yield of a roll formed hub while eliminating the need for a central bolt or stub shaft to retain the bearing assembly within this hub assembly.

### SUMMARY

Generally described, the invention is a hub assembly that includes a roll formed hub, at least one bearing enabling rotation of the hub assembly, an inner ring of a bearing assembly, which is in contact with the at least one bearing and the roll formed hub, and a fusion weld to lock the inner ring to the roll formed hub.

More particularly described, the fusion weld can be a laser weld. The fusion weld extends 360 degrees around the inner ring at a point of when the inner ring is in communication with the roll formed hub. Alternatively, the fusion weld can be an electron beam weld.

A method of retaining a wheel bearing is also described. The method includes providing a roll formed hub, placing an inner ring of a bearing assembly in contact with the roll formed hub and the bearing, and welding the roll formed hub to the inner ring with a fusion weld, thereby locking the inner ring to the roll formed hub.

In addition, an improved hub assembly is described. The hub assembly can include a roll formed hub, an inner ring in proximity to the roll formed hub, and a wheel bearing in proximity to the inner ring. The improvement includes a fusion weld locking the roll formed hub to the small inner ring, wherein the fusion weld increases an amount of force required to create an end play on the wheel bearing.

Moreover, a wheel system is described, which includes an axle assembly and a roll formed hub in contact with the axle assembly. The roll formed hub includes a roll formed hub, a bearing assembly in contact with the axle assembly, and the roll formed hub and a fusion weld assembly linking the bearing assembly to the roll formed hub. The bearing assembly further includes at least one bearing, a race, and an inner ring in contact with the bearing.

The various aspects of the embodiments of the present invention may be more clearly understood and appreciated from a review of the following detailed description of the disclosed embodiments and by reference to the appended drawings and claims.

### BRIEF DESCRIPTION OF THE DRAWINGS

FIG. 1 is a cross sectional perspective illustrating a portion of a hub assembly in accordance with an embodiment of the present invention.

### DETAILED DESCRIPTION OF THE DRAWINGS

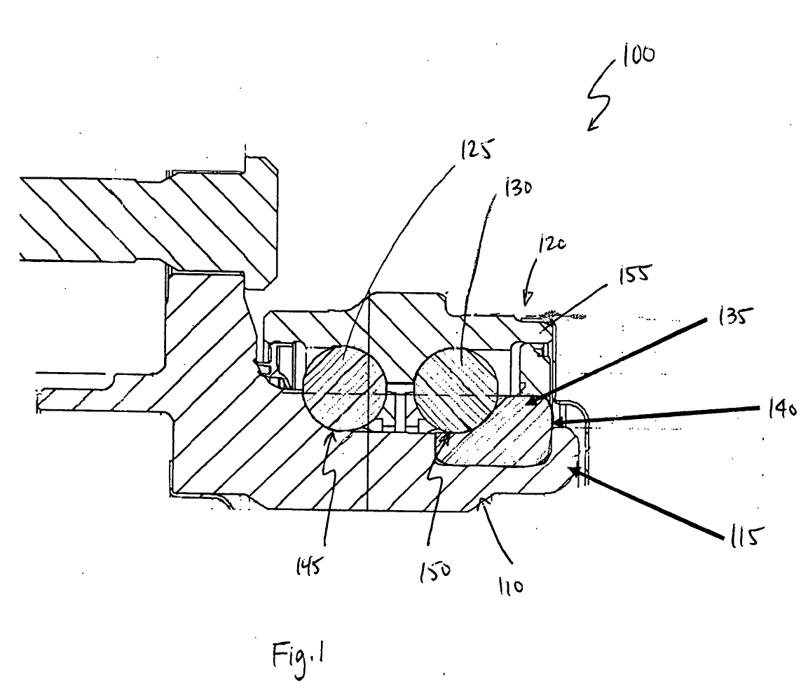

Referring now to the above figures, wherein like reference numerals represent like parts throughout the several views. FIG. 1 depicts a cross sectional view of a portion of a hub assembly 100 in accordance with an embodiment of the present invention. The hub assembly 100 includes a roll formed hub 110 and a bearing assembly 120. The roll formed hub 110 includes a distal end of the axial inner end portion of the roll formed hub 110 that is rolled to form a shoulder 115. The shoulder 115 is used to place a pre-load on the bearing assembly 120 to lock it in place.

The bearing assembly 120 includes at least one bearing 125, a race 155, and an inner ring 135. The at least one bearing 125 can be an assembly of hardened precision rollers designed to minimize friction at an axle assembly (not depicted) and the hub assembly 100. In one exemplary embodiment, the bearing assembly 120 includes an outer bearing 125 and an inner bearing 130. The outer bearing 125 and the inner bearing 130 may be either ball-type bearings or tapered roller bearings. The outer bearing 125 can rest in an outer raceway 145, which is formed by a first portion of the roll formed hub 110 and the race 155. The inner bearing 130 can rest within an inner raceway 150, which is formed by an inner ring 135 and the race 155. The inner ring 135 is held in place by the shoulder 115 of the distal end of the roll formed hub 110 by placing the inner ring 135 in a pre-load condition. In this manner, the shoulder 115 of the roll formed hub 110 and the inner ring 135 secure the bearing assembly 120 to the roll formed hub 110.

In an exemplary embodiment, the roll formed hub 110 can be made of un-hardened steel, such as, Society of Automotive Engineers (SAE) 1055 grade/strength carbon steel. One skilled in the art, however, can appreciate that the roll formed hub 110 can be made of other suitable carbon steels for the necessary stability required within the hub assembly 100.

In an exemplary embodiment, the inner ring 135 is made from through-hardened steel. For instance, SAE 52100 grade/strength chromium steel is commonly used in the bearing industry. In fact, SAE 52100 is high carbon chromium steel which also contains small amounts of manganese and silicon; this air-melted alloy is clean, hard, and wear resistant. One skilled in the art, however, will appreciate that the inner ring 135 can be made of other suitable hardened material capable of performing the necessary functions of the inner ring 135 in maintaining stability of the inner bearing 130, and adapted to withstand extreme operating conditions.

As noted above, the roll formed hub 110 is adapted to maintain a pre-load on the bearing assembly 120. For instance, under extreme driving conditions, a lateral load can be applied to the bearing assembly 120, which can cause the shoulder 115 of the roll formed hub 110 to yield or elongate. As the shoulder 115 yields, it can become separated from the inner ring 135. The yield created is commonly referred to as end play, which includes a clearance condition between the inner ring 135 and the bearings 125 and 130. The yield allows the bearings 125 and 130 to shift or move along the axis as roll formed hub 110 yields. This results in excessive heat on the bearings 125 and 130 and an increase in heat generation at the bearing/hub interface. The increased degradation to the bearings 125 and 130 can lead to wheel wobble and, in extreme circumstances, wheel separation.

The hub assembly 100 can also include a locking device 140, which is formed at the junction between the shoulder 115 and the inner ring 135 and rigidly affixes the shoulder 115 of the roll formed hub 110 to the inner ring 135. By affixing the shoulder 115 of the roll formed hub 110 to the inner ring 135, the shoulder 115 is securely held in place, thereby eliminating the yield of the shoulder 115, due to lateral forces applied to the roll formed hub 110. The fusion weld may extend 360 degrees around the inner ring 135 at the point where the inner ring 135 is in communication with the roll formed hub 110. In one embodiment, the locking device 140 is a fusion weld.

In fusion welding, a heat source melts the material, such as metal, to form a bridge between the components to be joined. Typically, the joints are attached as a “T” joint or a butt joint. Examples of fusion welding can include: laser welding, manual metal arc welding, submerged arc welding, metal inert gas welding, tungsten inert gas welding, electron beam welding, and the like. In particular, laser welding is typically used for reasonably higher specification welds, and is becoming widespread as the cost decreases. Laser welding permits a low distortion process and further lowers cost by not requiring filler wires.

In one exemplary embodiment, the fusion weld is a laser weld. The laser weld may be formed by directing the output of a laser on the range of approximately 20 kilowatts onto a small area to be welded. The laser liquefies the material, which solidifies behind the beam as it traverses the weld joint. This produces a weld bead with a width of approximately 1 millimeter. Because the weld bead is small, there is usually no need to grind or clean up the weld beam.

More importantly, since the surface heating generated by the laser light relies upon the heat conductivity of the material to form the weld beam, the heat affected zone is generally reduced over conventional welding methods and is on the order of approximately 0.5 millimeters. The reduced heat affected zone of the laser weld provides several advantages. The reduced heat affected zone of the laser does not penetrate the core depth of the hardened heat treated inner ring 135. This is an important feature since any penetration of the core depth by the heat affected zone of the weld would significantly weaken the heat-treated inner ring 135, which would reduce the life of the bearing assembly 120.

In other exemplary embodiments, the locking device 140 can include other welding techniques that have a small heat affected zone (approximately less than 1 millimeter). For instance, electron beam welding, which has a heat affected zone of approximately 0.5 millimeters, can be used. One skilled in the art will appreciate that other similar welding techniques that have a small welding bead and a small heat affected zone can be used, without departing from the scope of this invention.

The various embodiments of the present invention have been described with reference to the above discussed embodiments, but the present invention should not be construed to cover only these embodiments. Rather, these embodiments are only exemplary embodiments. Variations of the above exemplary embodiments may suggest themselves to those skilled in the art or others without departing from the spirit and scope of the present invention. The appended claims and their full range of equivalents should, therefore, only define the full scope of the present invention.

What is claimed is:

1. A hub assembly comprising:
a roll formed hub;
at least one bearing enabling rotation of the hub assembly;
an inner ring in communication with the at least one bearing and the roll formed hub; and
a fusion weld adapted to weld the inner ring to the roll formed hub.

2. The hub assembly of claim 1, wherein the fusion weld is a laser weld.

3. The hub assembly of claim 1, wherein the fusion weld is an electron beam weld.

4. The hub assembly of claim 1, wherein the roll formed hub comprises high carbon steel.

5. The hub assembly of claim 1, wherein the inner ring comprises high carbon steel.

6. The hub assembly of claim 1, wherein the fusion weld extends 360 degrees around the inner ring at the point of where the inner ring is in communication with the roll formed hub.

7. A method of retaining a wheel bearing, the method comprising:
providing a roll formed hub;
providing an inner ring in communication with the roll formed hub and the wheel bearing; and
welding the roll formed hub to the inner ring with a fusion weld, thereby locking the inner ring to the roll formed hub.

8. The method of claim 7, wherein the fusion weld extends 360 degrees around the inner ring at the point where the inner ring is in communication with the roll formed hub.

9. The method of claim 7, wherein the fusion weld is a laser weld.

10. The method of claim 7, wherein the fusion weld is an electron beam weld.

11. In a hub assembly comprising (i) a roll formed hub, (ii) a inner ring in proximity to the roll formed hub, and (iii) a wheel bearing in proximity to the inner ring, the improvement comprising a fusion weld locking the roll formed hub to the inner ring, wherein the fusion weld increases an amount of force required to create an end play on the wheel bearing.

12. The improved hub assembly of claim 11, wherein the fusion weld extends 360 degrees around the inner ring at the point where the inner ring is in communication with the roll formed hub.

13. The improved hub assembly of claim 11, wherein the fusion weld is a laser weld.

14. The improved hub assembly of claim 11, wherein the fusion weld is an electron beam weld.

15. The improved hub assembly of claim 11, wherein the roll formed hub comprises un-hardened high carbon steel.

16. The improved hub assembly of claim 15, wherein the inner ring comprises hardened high carbon steel.

17. A system, comprising:
an axle assembly;
a roll formed hub in communication with the axle assembly comprising:
a roll formed hub;
at least one bearing assembly in communication with the axle assembly and the roll formed hub; and
a fusion weld linking the bearing assembly to the roll formed hub.

18. The system of claim 17, wherein the bearing assembly comprises:
at least one bearing;
a race; and
an inner ring in communication with at least one bearing.

19. The system of claim 18, wherein the fusion weld locks the roll formed hub to the inner ring.

20. The system of claim 17, wherein the fusion weld is a laser weld.

21. The system of claim 17, wherein the fusion weld is an electron beam weld.

22. The system of claim 18, wherein the fusion weld extends 360 degrees around the inner ring at the point of where the inner ring is in communication with the roll formed hub.
